(19) United States
(12) Patent Application Publication
(10) Pub. No.: US 2005/0110883 A1
(43) Pub. Date: May 26, 2005

(54) Image property translator

(76) Inventor: Brent H. Allen, Beavercreek, OH (US)

Correspondence Address: DINSMORE & SHOHL LLP;One Dayton Centre, Suite 1300, One South Main Street, Dayton, OH, 45402-2023, US

(21) Appl. No.: 10/976,602

(22) Filed: Oct. 29, 2004

Related U.S. Application Data
(60) Provisional application No. 60/524,712, filed on Nov. 24, 2003.

(51) Int. Cl. H04N 5/262

(52) U.S. Cl. 348/239

(57) ABSTRACT

A method and system of viewing images created by different types of sensors such that the visual qualities of the viewed images are similar is disclosed. An image is obtained by a first sensor. The image is modified so that the modified image has characteristics similar to those achieved as if the image had been obtained by a second type of sensor. An object of interest may be selected from the image. A current image is obtained by the second sensor. The modified image and the current image are then displayed. Multiple images may be transformed, displayed, and compared to other images. Computer-aided detection marks can be displayed on the current image from the second sensor as well as the modified image.

### CROSS-REFERENCE TO RELATED APPLICATIONS

This application claims the benefit of U.S. Provisional Application No. 60/524,712 filed Nov. 24, 2003 which is incorporated herein by reference.

### BACKGROUND OF THE INVENTION

1. Field of the Invention

The present invention generally relates to a method and system for viewing imagery and, in particular, relates to a method and system for transforming digital images created by a first sensor such that the transformed images appear as if they were created by a second sensor which has different characteristics than those of the first sensor.

2. Discussion of Background

Over the past two or three decades, screen-film mammography (SFM) has greatly aided the detection of early breast cancers. Annual screening of women age 40 and older has lowered breast cancer deaths by as much as 30 percent. Nonetheless, as many as one in five cancers still are overlooked because the mammographic changes may be very subtle. Full-field digital mammography (FFDM) may help locate some of these cancers. In contrast to conventional film mammography, which uses radiographic film to acquire, store and display an image, FFDM conveniently offers a means of separating these functions. Further, FFDM has a number of attributes that may help a small breast tumor stand out from surrounding normal tissue: the efficient absorption of incident x-ray photons, a linear response over a broad range of radiation intensity, and comparatively little system “noise” (extraneous information).

In SFM, x-ray energy is converted to light which exposes a film. Conventional SFM uses low energy x-rays that pass through a compressed breast during a mammographic examination. The exiting x-rays are absorbed by film which is then developed and subsequently reviewed by the radiologist. This traditional process is analogous to personal photographic cameras and photographic film where light is focused on the film and developed to produce a negative which can be printed as a picture.

FFDM systems, on the other hand, directly create digital mammograms. With FFDM, low energy x-rays pass through the breast as in conventional mammograms but are recorded by means of an electronic digital detector instead of film. This electronic image can either be displayed on a video monitor similar to a television or printed onto film. Again, this is similar to digital cameras that produce a digital picture that can be displayed on a computer screen or printed on paper. The radiologist can manipulate the digital mammogram electronically to magnify an area, change contrast, or alter the brightness. Like SFM, FFDM uses x-rays to produce images of breast tissue. The difference is that with FFDM, an electronic x-ray detector replaces the film cassette and converts the x-ray photons to light, which in turn passes to a device that converts the light to a digitized signal for display on a monitor. A monitor in the examination room allows the mammographic technologist to view the mammogram in several seconds instead of developing films and waiting ten minutes to see an image. The radiologist can alter the orientation, magnification, brightness and contrast of the images as desired.

Typically, when radiologists interpret mammograms- usually four films for a patient, two views of each breast - the images from the current exam are compared to the images from the prior exam, usually created two or three years earlier. The issue becomes how to conveniently display and compare the film images with FFDM images. One obvious problem is that films must be displayed on a light box while FFDM images must be displayed on a monitor, thereby requiring two disparate types of equipment. One solution is to create digital images of the films with a digitizer, then display the resultant images on a monitor with the FFDM images. However, without additional processing, the displayed images are not well-suited for comparison. The digitized film images and FFDM will generally have markedly different intensity value distributions and physical dimensions. Alternatively, a digital image may be printed on film and subsequently viewed on a lightbox. Although this would allow comparison of images from both sensors to be compared on a lightbox, it involves the time and expense of printing additional film. Furthermore, the printed film image is not likely to have similar visual characteristics as the original SFM images.

Therefore, a need exists for a method and system for viewing images created by different types of sensors such that the visual qualities of the viewed images are similar. This is important so that when the images from the two different types of sensors are viewed for comparison purposes on one or more monitors, the images have similar visual characteristics.

### SUMMARY OF THE INVENTION

When images from two different types of sensors are viewed for comparison purposes, it is beneficial to modify the images such that both images have similar visual characteristics Therefore, the present invention allows for the viewing of images created by different types of sensors to have similar visual qualities when viewed together. An image is obtained by a first sensor. The image is modified so that the resulting image has characteristics similar to those achieved as if the image had been obtained by a second type of sensor. An object of interest may be selected from the image. A current image is also obtained by the second sensor. The modified image and the current image are then displayed. Multiple images may be transformed, displayed, and compared to other images. Additionally, computer-aided detection marks can be displayed on the current image from the second sensor as well as the composite image.

Accordingly, it is an object of the present invention to transform images created by a first sensor such that the transformed images appear as if they were created by a second sensor having different characteristics than first sensor.

It is another object of the present invention to facilitate viewing and comparison of images created by the first and second sensor types.

It is yet another object of the present invention to facilitate viewing and comparison of mammographic images created by screen-film mammography with those created by full-field digital mammography.

Other objects and advantages of the present invention will be apparent in light of the following description of the invention embodied herein.

### BRIEF DESCRIPTION OF THE DRAWINGS

The following detailed description of specific embodiments of the present invention can be best understood when read in conjunction with the following drawings, where like structure is indicated with like reference numerals, and in which:

FIG. 1 is a block diagram illustrating the transformation process according to an embodiment of the present invention;

FIG. 2 illustrates the transformation curve from a full-field digital mammography sensor to a film digitizer according to an embodiment of the present invention;

FIG. 3 illustrates the mapping from a film digitizer to a full-field digital mammography sensor according to an embodiment of the present invention;

FIG. 4 illustrates the effects of inverting the transformation from a film digitizer to a full-field digital mammography sensor with the full-field digital mammography to film digitizer mapping according to an embodiment of the present invention;

FIG. 5 illustrates the effects of inverting the transformation from a full-field digital mammography sensor to film digitizer with the film digitizer to full-field digital mammography mapping according to an embodiment of the present invention;

FIG. 6 illustrates a breast mask before and after smoothing according to an embodiment of the present invention;

FIG. 7 illustrates the margin dimming of the re-sampled image according to an embodiment of the present invention;

FIG. 8 is a comparison between a fabricated full-field digital mammography and an actual full-field digital mammography according to an embodiment of the present invention; and

FIG. 9 is an example of a display of current full-field digital mammography images and prior digitized images according to an embodiment of the present invention.

### DETAILED DESCRIPTION OF THE PREFERRED EMBODIMENTS

In the following detailed description of the preferred embodiments, reference is made to the accompanying drawings that form a part hereof, and in which are shown by way of illustration, and not by way of limitation, specific preferred embodiments in which the invention may be practiced. It is to be understood that other embodiments may be utilized and that logical, mechanical and electrical changes may be made without departing from the spirit and scope of the present invention.

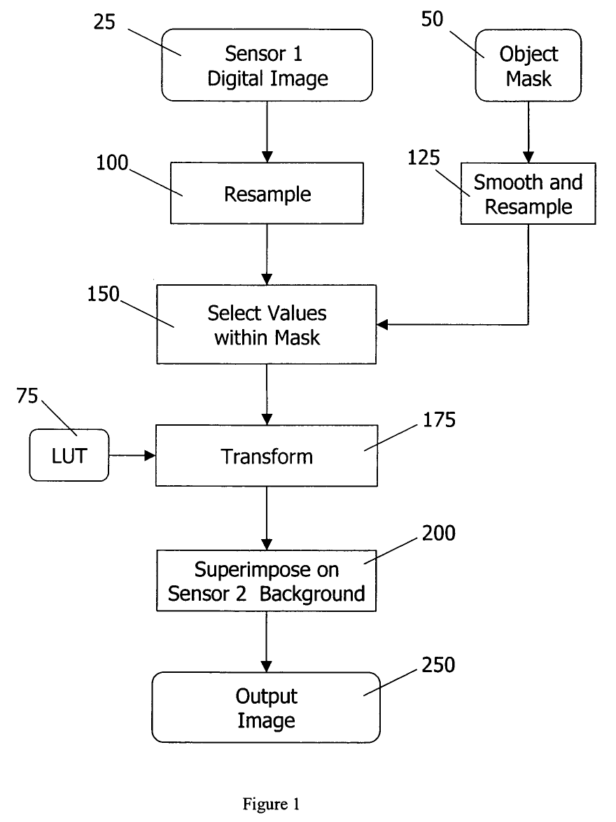

An overview of the method is shown in FIG. 1. The primary objective is to transform an input image acquired with a first sensor such that the transformed output image has the characteristics of an image acquired with a second sensor. First, the input image from Sensor 1, 25, is resampled in step 100 to provide the desired inter-pixel spacing (IPS) in the output image, 250. The object mask, 50, is a binary image derived from the input image, 25, having ON pixels at locations determined to contain an object of interest. The object mask is smoothed and resampled in Step 125. Then in step 150, pixel values from areas located within the object of interest are selected from the resampled input image. In step 175, the selected pixel values are transformed according to the lookup table (LUT), 75. The transformed pixel values are then superimposed on a typical Sensor 2 background in step 200, providing the output image, 250.

In one embodiment, the present invention describes the viewing of mammographic images. Therefore, during the description, the first sensor would represent a film digitizer and the second sensor would represent an FFDM device. The film digitizer can be, for example, a Howtek Fulcrum and 861 series film digitizers, a VIDAR DiagnosticPro and SIERRA plus film digitizers, Kodak LS 40 and LS 70 film digitizers, or any other similar type film digitizer. The FFDM device can be, for example, a General Electric Senographe FFDM device, Fischer Imaging Corporation SenoScan device, Hologic, Inc. Lorad® Digital Breast Imaging device, Siemens Mammomat Novation DR device or any other similar type FFDM device. In this situation, the invention provides a method for transforming digitized film images such that they appear as if they were created by an FFDM device.

### Film Digitizer to FFDM Lookup Table

A lookup table 75 converts the digitized film intensity values to FFDM intensity values. The lookup table, 76, is obtained from the characteristic curves of the film digitizer and FFDM system. The characteristic curve of the film digitizer defines the mapping from optical density to digital image gray level values. For an FFDM system, the characteristic curve defines the mapping from exposure to digital image gray level values. Characteristic curves can be empirically derived using calibrated step wedge targets with knowledge of the sensor type.

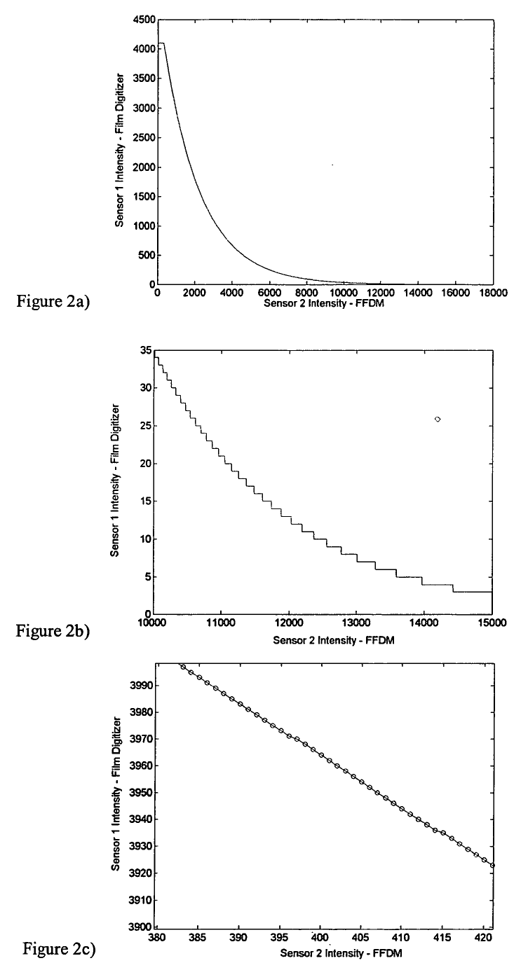

A method for obtaining a look up table to map FFDM values to film digitizer values is described in U.S. patent application Ser. No. 10/682,687, entitled “Methods for sensor independence in computer-aided detection systems,” filed on Oct. 9, 2003. FIG. 2(a) plots an FFDM device to film digitizer look up table. However, the desired mapping of the present invention is from a film digitizer to an FFDM device. Therefore, the LUT obtained for mapping FFDM device values to film digitizer values must be inverted.

FIG. 2(b) shows details of the LUT for FFDM intensity values between 10,000 and 15,000. This plot shows that at certain input intensities, a plurality of FFDM intensities are mapped to individual film digitizer intensities. This result is a consequence of FFDM intensities being represented with fourteen bits while film digitizer intensities are represented by twelve bits—corresponding to four times as many available FFDM intensities as film digitizer intensities. Also, there are gaps in the FFDM-to-film digitizer LUT such that no FFDM intensity is mapped to certain film digitizer intensities, as shown in FIG. 2(c). In this figure, circles indicate the points of the transformation. Note that for each single step increase in sensor 2 intensity value, the value of sensor 1 decreases by two steps. For these reasons, inversion of the FFDM to film digitizer LUT is not well-defined.

The algorithm for the FFDM-to-film digitizer LUT inversion works as follows. Each film digitizer intensity is mapped to the rounded average of the FFDM intensities that are mapped to it. If there are no FFDM intensities mapped to a film digitizer intensity, then the next lower intensity that has FFDM intensities mapped to it is used. The next lower intensity was used rather than the next higher intensity to avoid mapping film digitizer intensities 4093 and 4094 to the same FFDM intensity as 4095, which has 335 FFDM intensities mapped to it.

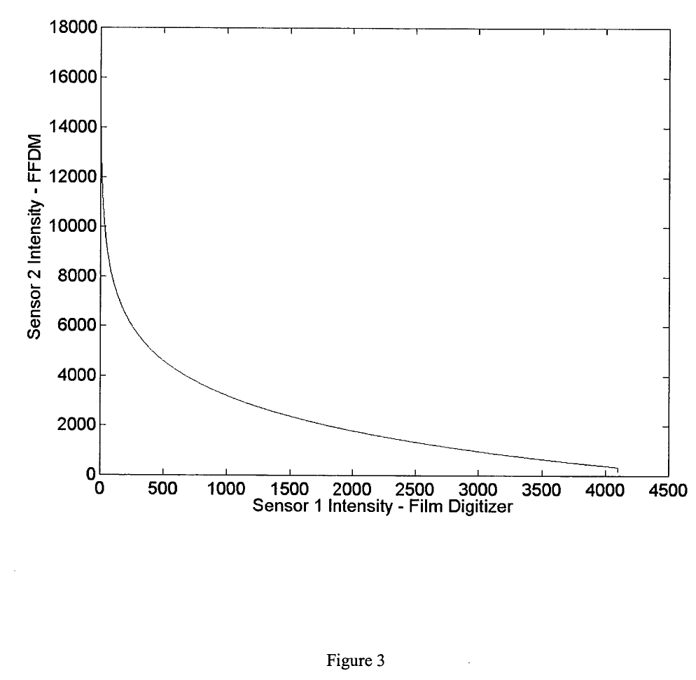

The minimum film digitizer intensity, 0, is treated as a special case and is mapped to the maximum FFDM intensity,16383. This is because no FFDM intensities are mapped to film digitizer 0, and there are no lower film digitizer intensities. The inverted LUT, for mapping film digitizer values to FFDM values is shown in FIG. 3.

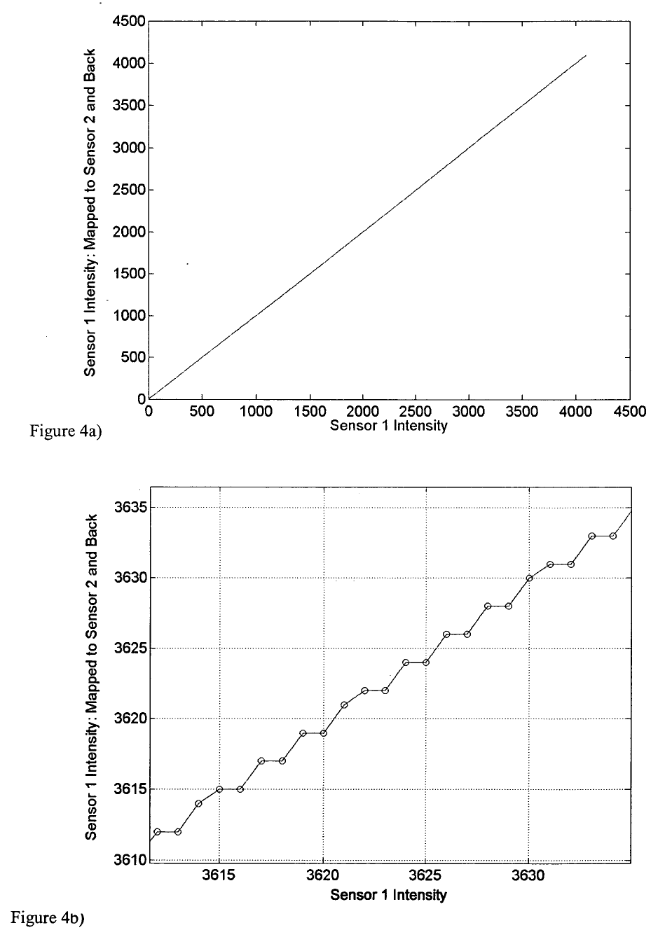

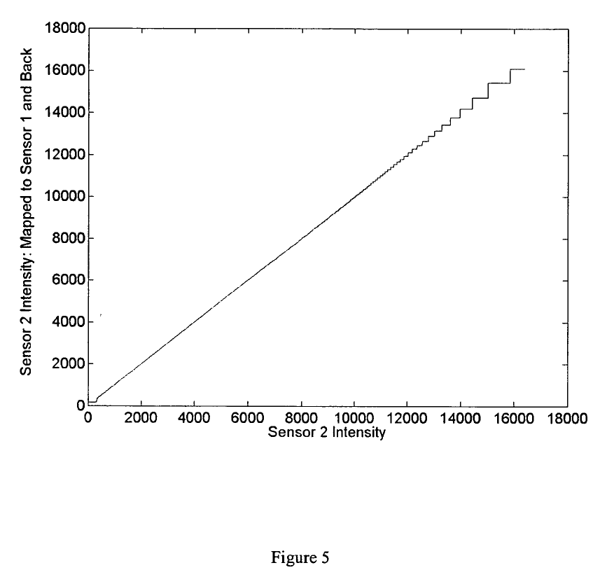

FIG. 4(a) shows the effects of transforming film digitizer values to FFDM values with the LUT of FIG. 3, then back to film digitizer values with the LUT of FIG. 2(a). FIG. 4(b) shows details of the transformation for original sensor 1 intensity values from 3612 to 3634. FIG. 5 shows the effects of transforming the FFDM values to film digitizer values with the LUT of FIG. 2(a), and then back to film digitizer values with the LUT of FIG. 3.

If the LUTs were both truly invertible, then the transformations in FIGS. 4(a) and 5 would be straight lines. The inversion limitations are more evident in FIG. 5 because the FFDM-to-film digitizer LUT is less invertible than the film digitizer-to-FFDM LUT. Given the characteristics of the sensors, the resultant film digitizer-to-FFDM LUT is optimal.

### Transformation Procedure

The inputs to the transformation procedure are the full-resolution digitized film image and object mask. Referring to FIG. 1, the input image is re-sampled in step 100. The up and down sampling factors are chosen such that the resultant IPS becomes substantially equivalent to the IPS of the FFDM sensor, in this case, 94.1 microns. Using replication up-sampling by 5 and average down-sampling by 11, the IPS of the re-sampled image becomes (11/5)^{ths} of the IPS in the input image. For a film digitizer with an IPS of 43.5 microns, the resultant IPS becomes 95.7 microns. If memory constraints are an issue, the re-sampled image may be computed without explicit up-sampling and sub-sampling.

In a mammographic application, the object mask corresponds to a breast mask, wherein ON pixels of the breast mask denote image pixels representing breast tissue. In step 125, the breast mask is smoothed and re-sampled. In the smoothing process, the edges of the mask that have sufficient ON pixels are first padded. Then, the mask is convolved with an averaging kernel. The averaged mask is unpadded and re-thresholded, producing an intermediate mask. The intermediate mask is ANDed with the original breast mask, producing a first smoothed mask.

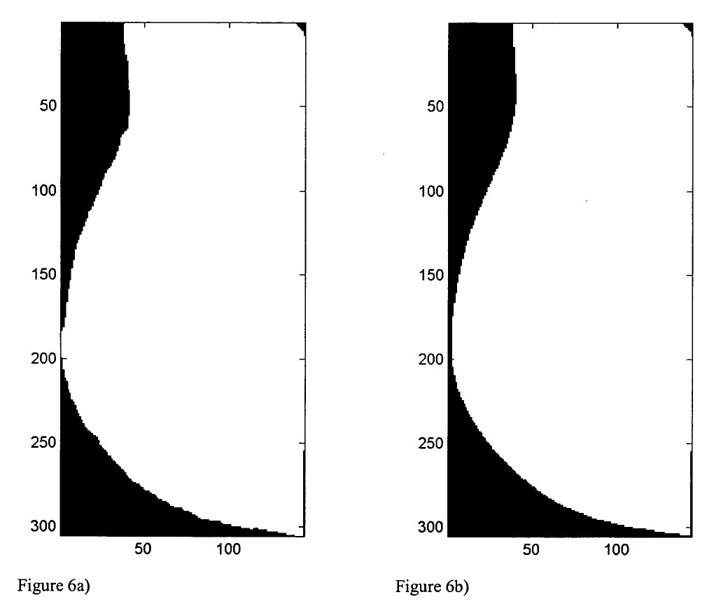

The original IPS for the digital representation of the breast mask is converted to the IPS of the FFDM sensor by re-sampling. The first smoothed breast mask is re-sampled from an IPS of 696 microns to an IPS of 95.7 microns using up- and down-sampling factors of 80 and 11. The re-sampled mask is then smoothed again using the method described above. FIGS. 6(a) and 6(b) show examples of both the original and smoothed breast masks.

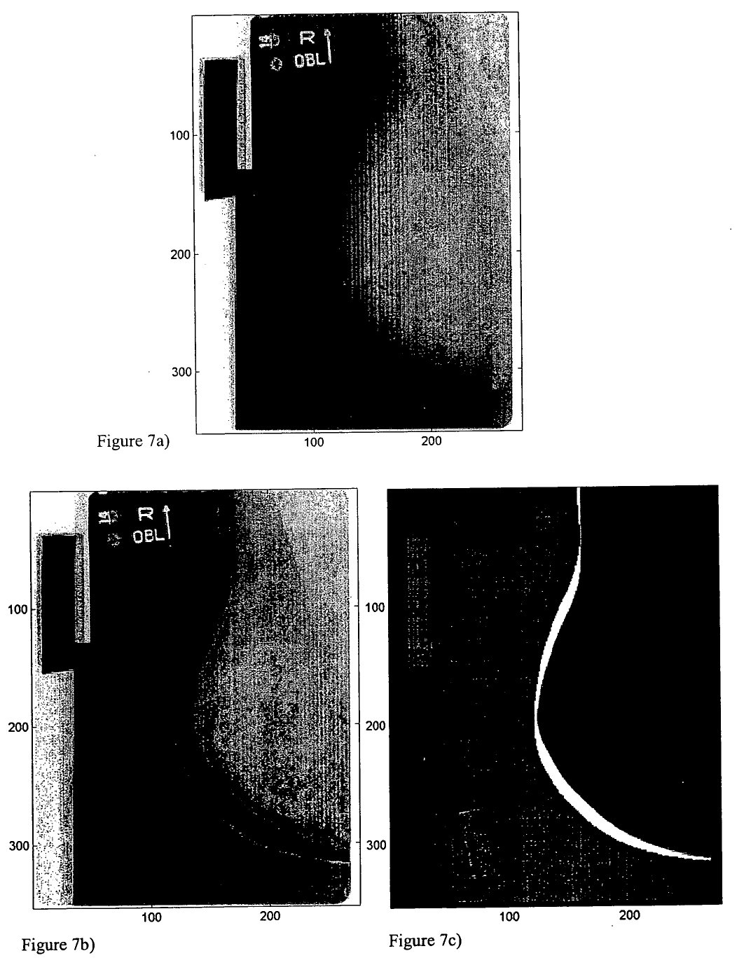

Before transforming the film digitizer pixel intensities with the LUT, the margin of the breast image is dimmed. The margin of the breast image is defined as the area between the edge of the re-sampled breast mask and the edge of an eroded version of the re-sampled breast mask. The dimming is accomplished by weighting the intensity of each pixel in the margin of the breast image by the factor (1−d²/d_{eroded}²), where d is the minimum distance from the pixel to the eroded perimeter, and d_{eroded} is the distance the mask was eroded. FIG. 7(a) is an input image and FIG. 7(b) shows the effects of dimming the margin.

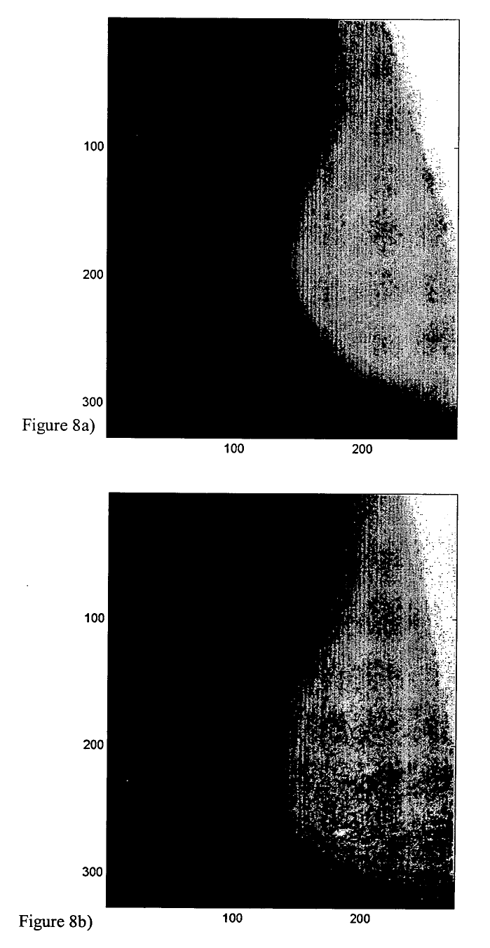

Next the pixel intensities of the re-sampled and dimmed image are transformed with the film digitizer-to-FFDM LUT. The resultant image is shown in FIG. 7(c). Then the breast area is cropped from the transformed image and superimposed on a properly sized FFDM-style background, yielding the raw pseudo-FFDM image. FIG. 8 compares a pseudo-FFDM image, FIG. 8(a), to an actual FFDM image, FIG. 8(b). For presentation purposes only, both these images are displayed after transformation with the FFDM-to-film digitizer LUT.

### EXAMPLE

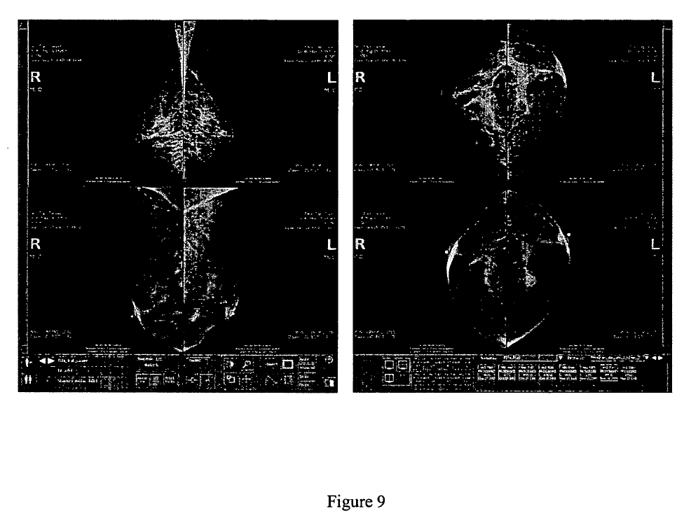

The method and system described transforms digitized film images to be visually compatible and consistent with FFDM digital images in terms of pixel spacing, gray levels, and overall appearance. An example of the results produced are shown in FIG. 9. The upper portion of the figure shows a set of transformed digitized film images, representative of a prior mammographic exam with a film-based mammography system. The lower portion of the figure shows a set of FFDM images, representing a current mammographic exam with an FFDM system. The system allows a radiologist to compare prior film exams to a current digital exam without the need for a light box. Furthermore, the image characteristics of the breast tissue in the prior exam are similar to those of the current exam. Additionally, the background image characteristics are also similar for the prior and current exams.

### Use with Computer-Aided Detection System

In one embodiment of the present invention, computer-aided detection (CAD) results are displayed on the images from the current digital exam only, as shown in FIG. 9. In another embodiment, the CAD results are displayed on both the prior and current images.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

1. A method for creating imagery comprising:
obtaining a first image by a first sensor;
modifying said first image of said first sensor to have characteristics similar to those achieved as if said first image of said first sensor were imaged by a second sensor;
obtaining a second image from said second sensor; and
displaying both said modified first image and said second image.

2. The method of claim 1, wherein said first image and said second image are obtained from imaging biological components.

3. The method of claim 1, wherein said first image is a digital representation of a film image.

4. The method of claim 1, wherein modifying comprises re-sampling said first image to achieve a desired inter-pixel spacing on said first image.

5. The method of claim 1, wherein modifying comprises re-sampling said first image such that the resulting inter-pixel spacing becomes substantially equivalent to the inter-pixel spacing of said second image of said second sensor.

6. The method of claim 5, wherein inter-pixel spacing of said re-sampled first image is the product of said inter-pixel spacing of said first image of said first sensor and a ratio of the average down-sampling factor by the replication up-sampling factor of said inter-pixel spacing of said first image of said first sensor.

7. The method of claim 1, wherein modifying further comprises selecting an object of interest from said first image.

8. The method of claim 7, wherein selecting comprises creating an object mask, wherein said object mask is a binary image derived from said digital representation of said film image of said first sensor having ON pixels at locations determined to contain an object of interest.

9. The method of claim 8, wherein said object mask is smoothed and re-sampled.

10. The method of claim 7, wherein modifying further comprises producing a foreground image of said modified image.

11. The method of claim 10, wherein modifying further comprises inserting said selected modified object into a background representative of a background image provided by said second sensor, producing a transformed composite image.

12. The method of claim 1, wherein modifying said first image comprises using a lookup table.

13. The method of claim 12, wherein said lookup table is obtained from characteristic curves of said first sensor and said second sensor.

14. The method of claim 13, wherein said characteristic curves are empirically derived using calibrated step wedge targets with knowledge of sensor type.

15. The method of claim 13, wherein said characteristic curves of said first sensor defines the mapping from optical density to digital gray level values.

16. The method of claim 13, wherein said characteristic curves of said second sensor defines the mapping from exposure to digital image gray level values.

17. The method of claim 12, wherein said lookup table for mapping said second sensor values to said first sensor values is inverted.

18. The method of claim 17, wherein inverting said lookup table comprises the steps of:
mapping the intensity of said first sensor to the rounded average of the said second sensor intensities that are mapped to it;
using the next lower intensity that has a second sensor intensity mapped to it if no second sensor intensity mapped to the first sensor intensity; and
setting the minimum first sensor intensity to the maximum second sensor intensity.

19. The method of claim 1, wherein said first sensor is a film digitizer.

20. The method of claim 19, wherein said film digitizer is one of a Howtek Fulcrum and 861 series film digitizers, a VIDAR DiagnostivPro film digitizer, a VIDAR SIERRA plus film digitizer, a Kodak LS 40 film digitizer, a Kodak LS 70 film digitizer or combinations thereof.

21. The method of claim 1, wherein said second sensor is a full-field digital mammography device.

22. The method of claim 21, wherein said full-field digital mammography device is one of a General Electric Senographe device, a Fischer Imaging SenoScan device, a Hologic Lorad Digital Breast Imaging Device, a Siemens Mammomat Novation DR device or combinations thereof.

23. The method of claim 1, further comprising:
creating imagery for multiple images.

24. The method of claim 23, wherein said multiple images are from a mammographic examination.

25. The method of claim 24, further comprising:
displaying computer-aided detection marks on at least one of said multiple images from said mammographic examination.

26. The method of claim 24, further comprising:
displaying imagery of a current mammographic examination from said second sensor.

27. The method of 26, further comprising:
displaying computer-aided detection marks on said displayed imagery of said current mammographic examination from said second sensor.

28. The method of claim 27, wherein computer-aided detection marks are displayed on said modified image of said first sensor and from said displayed imagery of said current mammographic examination from second sensor.

29. A method for creating mammographic imagery comprising:
obtaining a mammographic digital representation of a film image by a film digitizer;
selecting an object of interest from said mammographic digital representation;
modifying the selected object by producing a foreground image such that the modified object will have characteristics similar to those achieved as if the object were imaged by a full-field digital mammography device;
inserting the modified selected object onto a background image representative of the background image provided by said full-field digital mammography device, producing a transformed composite image; and
displaying the composite image.

30. The method of claim 29, wherein selecting comprises creating a breast mask, wherein said breast mask is a binary image derived from said mammographic digital representation of said film image of said film digitizer having ON pixels at locations determined to contain an object of interest and represent breast tissue.

31. The method of claim 30, wherein creating said breast mask comprises the steps of:
smoothing by padding the edges of said breast mask that have sufficient ON pixels;
convolving said breast mask with an averaging kernel;
unpadding and re-thresholding said averaged breast mask to produce an intermediate mask;
ANDing said intermediate mask with said original breast mask to produce said smoothed breast mask;
re-sampling said smoothed breast mask to achieve the inter-pixel spacing of said second sensor.

32. The method of claim 31, wherein modifying comprises dimming the margin of said mammographic digital representation.

33. The method of claim 32, wherein said margin is the area between said re-sampled breast mask and the edge of an eroded version of said re-sampled breast mask.

34. The method of claim 33, wherein dimming comprises weighting the intensity of each pixel in said margin by a function ranging from about 1.0 at said eroded edge of said re-sampled breast mask to about 0.0 at said edge of said re-sampled breast mask.

35. The method of claim 33, wherein dimming weights the intensity of each pixel in said margin by one minus the square of the minimum distance from the pixel to the eroded perimeter divided by the square of the distance said re-sampled breast mask was eroded.

36. The method of claim 32, wherein producing said foreground image by modifying said re-sampled breast mask comprises using a lookup table for transformation.

37. A system for creating imagery comprising:
a first sensor for obtaining a first image;
a second sensor for obtaining a second image;
a processor for modifying said first image such that the modified first image will have characteristics similar to those achieved as if said image were imaged by said second sensor; and
an output device for displaying said first image and said second image.
